(19) United States
(12) Patent Application Publication
(10) Pub. No.: US 2011/0192989 A1
(43) Pub. Date: Aug. 11, 2011

(54) SYSTEM AND METHOD FOR TREATMENT OF MATERIALS BY ELECTROMAGNETIC RADIATION (EMR)

(76) Inventors: Isaac Yaniv, Haifa (IL); Ben Zion Livneh, Denver, CO (US)

(21) Appl. No.: 12/999,348

(22) PCT Filed: Jun. 18, 2009
(86) PCT No.: PCT/IL09/00613

§ 371 Date: Apr. 28, 2011

Related U.S. Application Data
(60) Provisional application No. 61/129,336, filed on Jun. 19, 2008.

(51) Int. Cl. B01J 19/12

(52) U.S. Cl. 250/453.11

(57) ABSTRACT

Embodiments of the invention are directed to a system for treatment of material by microwave radiation. The system may include a casing, a waveguide connected to the casing to conduct microwave radiation from a radiation source into the casing, an inner container transparent to microwave radiation, the container having an inlet to receive material to be treated and an outlet to discharge treated material and a transport unit to carry the treated material.

### BACKGROUND OF THE INVENTION

Treatment of material such as coal may comprise extracting various substances from the material. For example, water contained in coal may be removed using various techniques. For example, a material may be heated, placed under pressure or mixed with other materials in order to extract or remove water, vapor or other substances. Problems related to extracting substances such as water from a material may be overheating of the material to a non-optimal temperature. For example, under-heating of the material may reduce efficiency while overheating may burn the treated material. Other problems may be hot spots that may develop in an inhomogeneous, heated material. Due to such and other problems, microwave radiation may not currently be efficiently used for treating a material as part of purification, upgrading or other processes such as for example, extracting water from coal or other minerals. An example may be removal of sulfur from coal via decomposition of Pyrite (FeS₂) present in the coal.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 shows an exemplary system according to embodiments of the invention;

FIGS. 2A-B show an exemplary system according to embodiments of the invention; and

FIG. 3 shows an exemplary multi-stack system according to embodiments of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may enable using electromagnetic radiation (emr) such as microwave (MW) radiation and/or radio frequency (RF) radiation for the treatment of a material. For example, MW radiation may be used to extract water from coal or from other minerals and/or materials by heating water contained in the coal thus causing the water to evaporate. Water contained in the material may be surface water resulting from exposing the material to external wet conditions such as rain, water or snow, or alternatively water locked in the material chemically or by a physical mechanism. The water may be locked for example in capillaries within the material. Other materials that may be treated by embodiments of the invention may be various fuels, e.g., renewable solid fuels or biomass.

In some embodiments, a first container or conduit may enclose, contain or otherwise confine material to be treated, e.g., coal. A wall of, or a window in such first container may be transparent with respect to MW radiation and accordingly may enable MW radiation to enter the space enclosed by the first container and consequently interact with material contained therein. A housing, casing or second container may contain or enclose the first container. The second container's walls or surface may be reflective, opaque or otherwise impenetrable with relation to MW radiation. Wave guides connected to the second container may convey or conduct MW radiation from a MW generator to the second container. Accordingly, MW radiation present in the second container may penetrate a wall or window of the first container and interact with material contained therein. A first opening in the first container may enable introducing or admitting material to be irradiated or otherwise treated into the first container. A second opening in the first container may enable removing or discharging material from the first container.

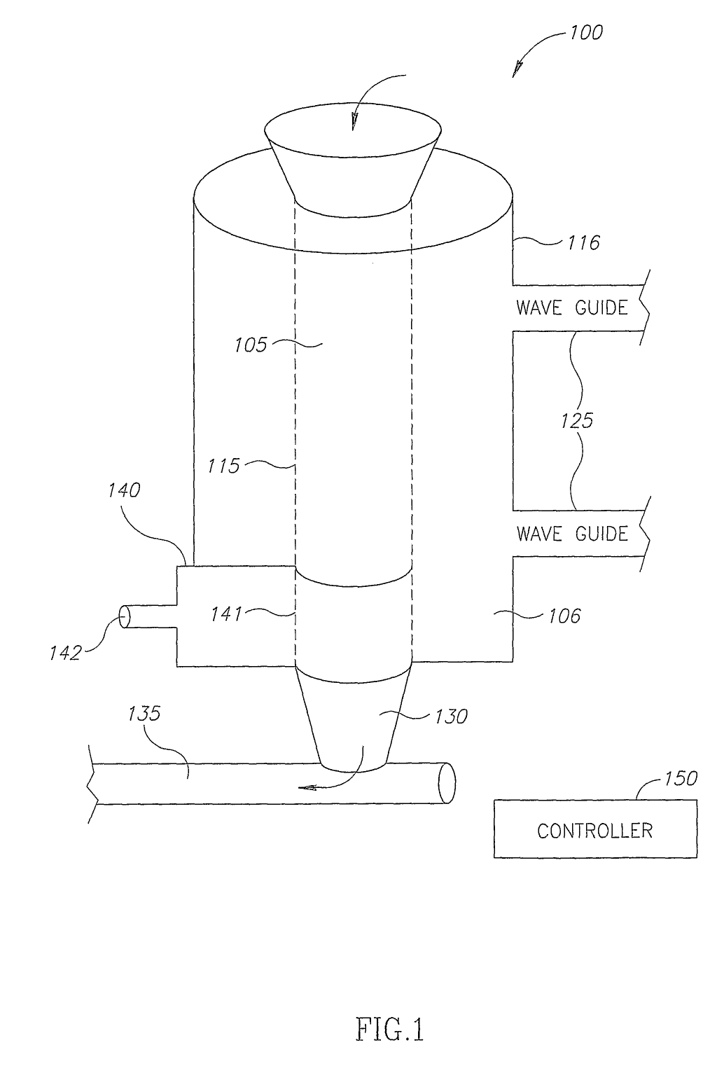

Reference is now made to FIG. 1 showing an exemplary system 100 according to embodiments of the invention. As shown, the system may include an inner container 105 to contain material to be treated. Container 105 may include walls 115. According to embodiments of the invention, at least a section, region or part of wall 115 may be transparent to MW radiation and accordingly may enable MW radiation to pass through it and interact with material, e.g., coal, contained in container 105. According to other embodiments, container 105 as a whole may be made of material transparent to MW radiation. Container 105 may be required to withstand considerable heat and friction and further allow passage of MW radiation.

In some embodiments, wall 115 may be made of materials that are harder than the treated materials. For example, wall 115 may be harder than coal so it can sustain friction with the coal. Wall 115 may be resistant to thermal shock or sever temperature gradients and may be transparent to MW radiation. Accordingly, exemplary substances used for fabrication of wall 115 may be ceramic or other compositions that may include, mullite, cordierite and/or alumina or materials or substances comprising such elements. According to other embodiments, container 105 may comprise a suitable polymeric material.

Wall 115 may be designed according to any applicable parameters. For example, the dimensions of wall 115 may define the capacity of container 105. The capacity of container 105 may be determined according to parameters such as MW radiation level, power or intensity, percentage or level of water or other substance that are to be extracted from treated material. For example, if a level or percentage of water to be extracted from treated coal is high, wall 115 may be made such that it defines a relatively small envelope containing a relatively small amount of coal. Accordingly, with a given level of MW radiation energy, a given volume of coal is subjected to higher energy levels. In other cases, for example, if the percentage of water in treated coal is low, and accordingly, lower energy levels are required, wall 115 may be made larger, defining a larger envelope that contains larger amount of coal. Accordingly, as a given MW radiation energy is now distributed over a larger amount of coal, a given volume of coal may be subjected to lower energy levels. Other than based on percentage of water in treated coal, dimensions or other aspects of wall 115 may be defined according to heat absorption coefficients of treated material, rate or level of penetration of radiation through wall 115, energy level of MW radiation, energy loses etc.

System 100 may comprise a second container, housing or casing 106 having a wall 116 as shown. In some embodiments, housing 106 may substantially surround, encase or enclose container 105, for example, as shown in FIG. 1. Accordingly, two spaces may be present, a first space between walls 116 and 115 and a second space being the inner space of container 105. The space defined by housing 106 and excluding container 105 may be filled with MW radiation introduced through waveguides 125 as described herein while the second space, defined by container 105 may be filled with material being treated, e.g., coal.

Housing 106 and its walls 116 may be opaque or otherwise impenetrable to MW radiation and may confine MW radiation to a space contained by housing 106. For example, wall 116 may be made or may comprise carbon steel or may be or comprise ferromagnetic substances. Alternatively, according to other embodiments, wall 116 may be an electrical conductive substance or material such that MW radiation may not penetrate it. System 100 may include one or more waveguides 125 as shown. Waveguides 125 may be connected to one or more MW generators or sources (not shown) and may conduct MW radiation produced or generated by a MW generator.

MW radiation received from a MW source and conducted by waveguides 125 may be distributed inside housing 106 and may enter container 105 through wall 115. Container 105 may be fitted with an inlet opening 120 as shown. Material to be treated may be introduced into container 105 via inlet 120. Container 105 may be fitted with an outlet 130 as shown. The treated material may exit container 105 through outlet 130. System 100 may include a material transport unit 135, also termed relocation unit. For example, unit 135 may be a conveyor belt capable of moving or extracting coal from outlet 130 or unit 135 may be a screw elevator or feeder as known in the art. Functional parameters of system 100 may be determined by unit 135.

For example, the capacity of system 100 in terms of amount of material treated per time, e.g., tons/hour and/or the time duration a given volume of material is treated may be determined by the rate with which unit 135 extracts or removes material. In some embodiments, rather than having a first container encased by a second container, container 105 and housing 106 may be two adjacent or adjoining containers separated by a wall transparent to microwave radiation. Accordingly, radiation introduced into housing 106 may penetrate through such a wall and interact with the material contained in container 105.

System 100 may include an extraction unit 140. Unit 140 may extract substance such as fumes, moisture or water from the treated material. As shown, unit 140 may have a screen 141 that may be a mesh or other filtering component capable of separating solids from vapors or liquids and/or separating small particles from larger ones. Accordingly, screen 141 may enable a passage of water, fumes or moisture from treated material to unit 140 while preventing passage of other substances. For example, while it may be impossible for coal to pass through wall 141 into unit 140, water or vapor may readily pass through screen 141. Unit 140 may be fitted with an outlet 142 as shown. Vacuum may be applied through outlet 142 and may be present inside unit 140, thus water or vapor may be actively pulled, sucked or drawn from coal or other substance through screen 141.

In some embodiments, substances such as particles, fumes, water or moisture may be forced out of treated material, e.g., from material in container 105 to outlet 142 by a pressure difference or variance between unit 140 and container 105 caused by the applied vacuum.

In other embodiments, another or an additional driving force for extracting or forcing substance out of treated material may be gases introduced into a treatment container, e.g., container 105. For example, pipes conduits or ducts may conduct gas, for example pressurized gas from a tank or another source and may deliver the gas into container 105. For example, gases may be introduced with coal into container 105. In some embodiments, the gases may be inert gases such as CO2, CO, Nitrogen etc. Inert gases introduced as described may increase the pressure in a treatment container thus causing a pressure difference between the treatment container and an extraction unit, such as unit 140. In addition, introducing inert gases as described may prevent treated material from burning thus enabling higher temperatures during a treatment process. For example, a temperature that may cause coal to burn may be exceeded, without the coal burning, in the presence of an inert gas mixed with coal.

Water, vapor or other substance extracted by unit 140 as described may be removed or discarded through outlet 142. Screen 142 may be made of a magnetic, conductive or ferromagnetic material in order to prevent a leakage of the microwave radiation from container 105.

Container 105 may be constructed of multiple circular, rectangular or similarly shaped pipes that may be stacked to form a cylinder or open ended container. A door, opening or window in container 106 (not shown) may enable service or maintenance. For example, cleaning wall 115, removal of obstacles that may be deposited in container 115, replacing container 105 or parts of container 105 and/or inspection.

In some embodiments, ground or pulverized coal may be admitted through inlet 120 and may be allowed to fill container 105 to a predefined capacity. MW radiation conducted by waveguides 125 may be distributed in container 116, may penetrate wall 115 of container 105 and may interact with, e.g., heat, coal contained therein. While the coal may be made to move or advance from inlet 120 to outlet 130 by gravitational force, the rate of such advancement or progress may be controlled. For example, a controller 150 may control material relocation unit 135 and may determine or regulate the rate at which coal is removed or extracted from outlet 130 thus controlling movement or flow of coal through container 105. Alternatively or additionally, the size of outlet 130 may be controlled by the controller to achieve similar results. Other operational or other parameters or aspects of system 100 may be controlled by controller 150. For example, the rate at which material is introduced into system 100 through inlet 120 may be controlled by controlling a feeder or conveyor supplying material (not shown) to inlet 120 or by controlling the size of inlet 120, or the level of the energy of the MW radiation may be controlled by controlling the power of the MW generator.

Controlling the rate or pace of movement of material through container 105 may determine the time a given volume or mass of material is being treated, e.g., exposed to emr. For example, reducing the rate with which material is being removed from outlet 130 may increase the time a given volume of coal is being irradiated while increasing the rate of removal of coal from outlet 130 may decrease irradiation time. According to embodiments of the invention, a controller controlling the removal rate of material from outlet 130 as described may do so based on a number of parameters. Exemplary parameters may be a level or percentage of water in untreated coal, a level or percentage of residual moisture or other substance in treated material after the irradiation process, a level or strength of radiation applied, the volume of container 105 or housing 106 and/or a dimension of wall 115 through which radiation is admitted as described herein. Any other applicable parameters may be used as input to a controller controlling material relocation unit 135 as described herein.

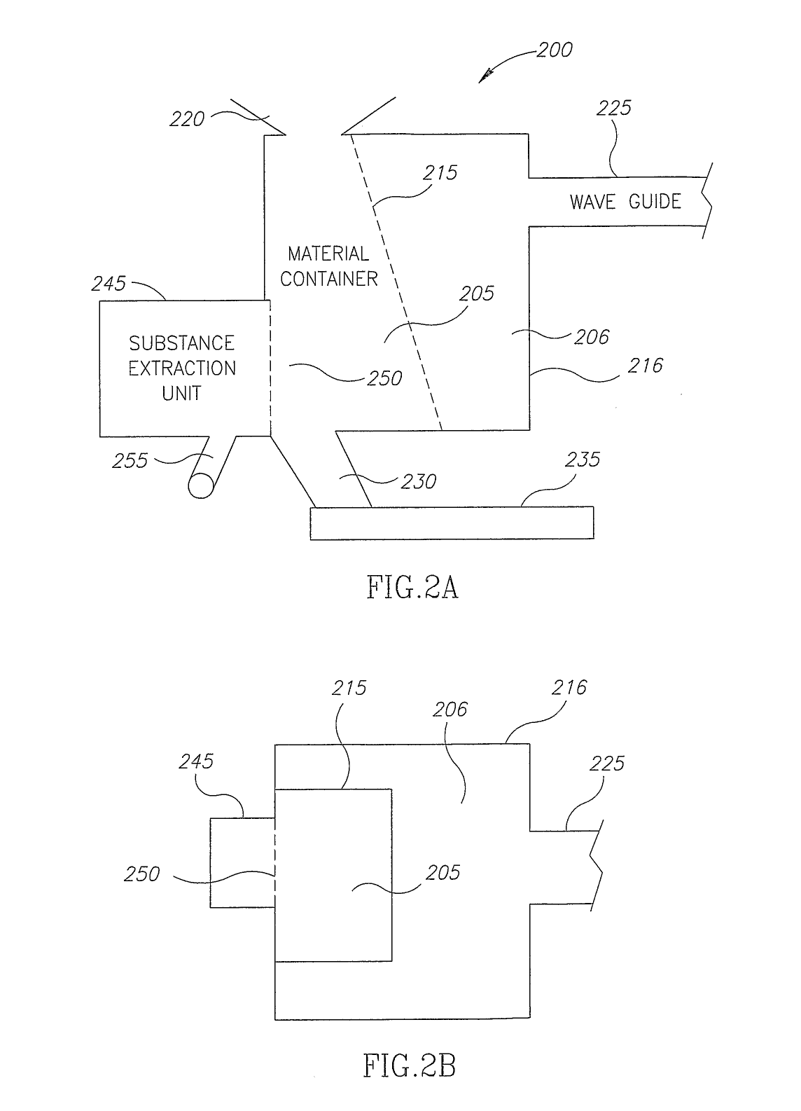

Reference is made to FIG. 2A showing a side section view of an exemplary system 200 according to embodiments of the invention. As shown, system 200 may include an admission opening 220 and a discharge opening 230 that may be similar to respective openings 120 and 130 described herein with respect to FIG. 1. While possibly differently shaped, container 206 and wall 216 may be similar to container 106 and wall 116 respectively. Likewise, waveguide 225 may be substantially similar to waveguides 125 described herein and transferring unit 235 may be similar to transferring unit 135.

As shown, container 205 may be shaped according to specific and/or dynamic requirements. According to embodiments of the invention, wall 215 may be designed or positioned such that the amount of material in container 205 varies along a predefined axis, e.g., a vertical axis. Having variable amounts of treated material submitted to a given amount of energy may enable controlling the amount of energy applied or provided to a given volume, weight, amount or other unit material. For example and as shown, wall 215 may be positioned or designed such that the amount of treated material at the top of container 205 may be lower than the amount at the bottom of container 205.

For example, coal admitted through opening 220 at the top of container 205 may contain high levels of water. Subjecting less coal to a given level of radiation may increase the amount of energy absorbed by a given volume of coal. Similarly, coal reaching the bottom of container 205 may have already been subjected to radiation and may contain less water than coal at the top. Accordingly, an increased amount of coal at the bottom of container 205 may cause a given volume or weight unit of coal to be subjected to lower levels of energy as energy may be divided over a larger amount of coal. Any suitable design of container 205 and/or wall 215 may be used by embodiments of the invention, for example, container 205 may be conically shaped so that an amount of the treated material at the bottom of container 205 is lower than the amount at the top or alternate between increased amount and decreased amount of material along the vertical axis of container 105 as may be required.

As shown by 245, system 200 may include a substance extraction unit. For example, extraction unit 245 may extract water, moisture or other substances from material in container 205. In one embodiment, vacuum may be used in order to pull, extract or otherwise force water or moisture out of coal being irradiated. In other embodiments, high pressure may be introduced to container 205 while extraction unit 245 may be maintained at ambient pressure thus a pressure difference as described herein may force substance to depart from the treated material and move to extraction unit 245. As described herein, pressurized inert gases, such as carbon dioxide, carbon monoxide, nitrogen and others may be introduced into container 205 and force or otherwise cause a desired substance to be extracted from the treated material and move from container 205 to extraction unit 245.

As shown by 250, a perforated wall, screen, mesh, strainer or surface may separate extraction unit 245 from material container 205. According to embodiments of the invention, screen 250 may enable small particles, liquids (e.g., water) and/or gas to pass through it while preventing substance such as coal or other materials from making such passage. Accordingly, vapor or water may be extracted from coal being treated. For example, vacuum present in unit 245 may be used to pull vapor or water from material in container 205. As shown, water or other extracted substance may be discharged through opening 255. According to the embodiment of the invention, the size of the particles that pass through wall or screen 250, for example small particles of treated coal, may be determined by the size openings, holes or apertures in wall 250.

Reference is made to FIG. 2B showing a top view of exemplary system 200. For the sake of simplicity, openings 220, 255 and 230 and unit 235 were omitted from FIG. 2B. As shown by FIG. 2B, container 205 may be at least partly encapsulated, enclosed, encased or contained in container 206. Container 205 may be of any suitable form or shape. For example, square or round shaped.

The material to be treated as described herein may be in the form of solid particles of any shape, distribution and size and of any chemical or other properties including inorganic materials such as natural minerals, ceramics, etc. Such material may be organic materials such as corn grains or wheat. According to embodiments of the invention, the treated materials may be any suitable organic, inorganic, minerals, solid or liquids and/or combinations thereof. Treating liquid materials such as water or milk may require replacing screen or wall 250 with a unidirectional pressure relieve gage.

Typically, when a substance is removed from a compound by applied energy, distribution of the applied energy within the compound may vary in relation to a progress of a relevant procedure. For example, the lower the relative amount or presence of a substance being removed from a carrier compound, the lower may the relative portion of the energy being utilized for the removal process be. For example, subjecting wet coal or coal containing high levels of moisture to radiation as described herein may result in high utilization of the applied radiation energy in relation to drying the coal. In contrast, subjecting relatively dry coal or coal containing low moisture levels to a similar treatment may result in a substantial portion of the energy being wasted or otherwise inefficiently utilized as it may heat the coal or other substances in the coal but fail to extract water.

Accordingly, in some embodiments of the invention, the amount of energy applied to a material or compound may vary dynamically or during a treatment of the material or compound. For example, as the percentage of moisture in the coal decreases the amount of applied energy may be decreased by lowering the level of energy produced by a related MW generator, reducing a size of a window through which radiation is allowed to reach the treated coal and/or increase the speed with which coal travels through the system and accordingly, reduce the time period during which coal is subjected to treatment. For example, the amount of radiation may be controlled by dynamically controlling the internals of the MW generator. In some embodiments, a time period during which material is subjected to MW radiation may be controlled. For example increasing the speed with which coal is transferred through the system, e.g., in the first container 105. For example, a rate at which coal is removed from an egress or exit opening of a container may be controlled thus also controlling the rate with which coal enters the container and the time the coal is present inside the container.

In some embodiments, the size of the surface through which energy is admitted and/or introduced may be controlled. For example, the size of an opening or window in a container, e.g., container 105, may be increased or decreased thus selecting an amount or portion of available energy to interact with material contained in the container. Embodiments of the invention may comprise treatment of material in a continuous mode and/or in a batch mode of operation. In a continuous mode, substance being treated may flow, pass or be transferred through an area where MW radiation is present as described herein. In batch mode, a substance may be stationary or motionless while being treated as described herein.

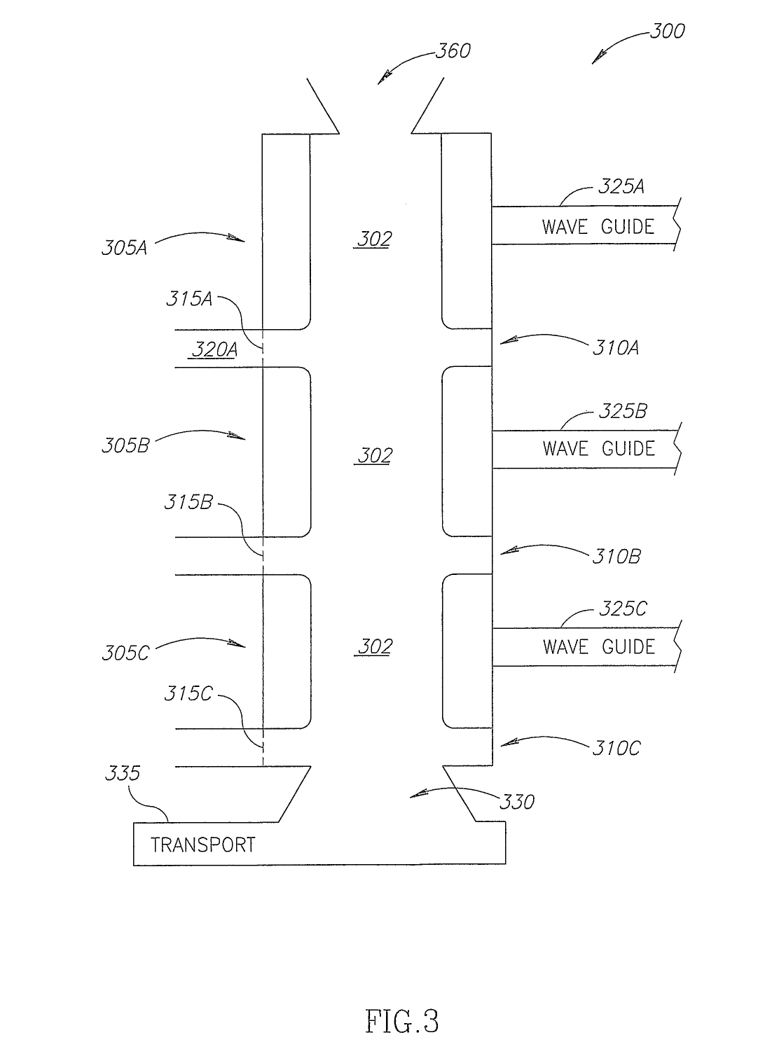

Reference is made to FIG. 3 showing an exemplary system 300 according to embodiments of the invention. As shown, system 300 may include a number of material treatment units 305A, 305b and 305C stacked vertically one on top of the other. Treatment units 305A-C may be similar to system 100 of FIG. 1. For example, treatment units 305A-C may include an inner containers 302 transparent to MW radiation and a magnetic casing 304 similar to inner containers 105 and casing 106 of FIG. 1. System 300 may further comprise waveguides 325A-C, which may be similar to waveguides 125 described herein with reference to FIG. 1.

According to embodiments of the invention, system 300 may include substance extraction units or zones 310A and 310B that may extract substance such as fumes, water, moisture or other substances from the treated material, which may be for example coal. Extraction units 310A and 310B may include screen 315A and 315B respectively that may be similar to screen 141 to enable passage of small particles or gases while prevent passage of larger particles. For example, screens 315A-B may be or may include a filter, a screen, a strainer, a mesh a membrane or any other suitable component capable of selectively restricting passage of substance.

System 300 may include conduits 320A-B that may be any suitable pipes or ducts and may carry the extracted substance such as water to a collection, treatment or disposal facility.

Vacuum may be applied to conduits 320A and 320B. Accordingly, water may be pulled, sucked or otherwise forced to move across screens 315A-B. Thus, water may be extracted from the treated material when moving from one treatment unit to the next treatment unit. Any suitable number of treatment units and any number of extraction units may be stacked or otherwise combined in other embodiments of the invention. Further, inner containers 302 may be at any suitable geometrical shape without departing from the scope of the invention.

Material may be introduced into system 300 via an inlet opening 360. For example, pulverized coal may be conveyed to opening 360. Material may be irradiated in treatment unit 305A and consequently, water contained in the material may evaporate. Material may flow through treatment unit 305A into substance extraction unit 310A where vacuum applied by duct 320A may force vapor or moisture through screen 315A thus vapor or water may be extracted from the material. The sequence described herein may be repeated by treatment unit 305B and extraction unit 310B. According to embodiments of the invention, any number of treatment units and/or extraction units may be stacked as shown by FIG. 3.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like.

Unless explicitly stated, the method embodiments described herein are not constrained to a particular order or sequence. Additionally, some of the described method embodiments or elements thereof can occur or be performed at the same point in time or overlapping points in time. While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A device for treating materials by electromagnetic radiation, the device comprising:
a casing;
a waveguide connected to the casing to conduct microwave radiation from a radiation source into the casing;
an inner container transparent to microwave radiation, the container having an inlet to receive material to be treated and an outlet to discharge treated material; and
a transport unit to carry the treated material.

2. The device of claim 1, wherein the casing is made of electrical conductive, ferromagnetic or magnetic material.

3. The device of claim 1, wherein the casing surrounds the container and creates a space confined between walls of the casing and walls of the inner container.

4. The device of claim 1, wherein the casing is divided into two spaces by a partition transparent to microwave radiation such that one of the spaces created the inner container.

5. The device of claim 1, wherein the material to be treated is fuel including coal, biomass or renewable solid fuel.

6. The device of claim 1, comprising a controller to control a rate of progress of the material through the inner container.

7. The device of claim 1, wherein the container is made of an alumina-based ceramic composition.

8. The device of claim 1, wherein the container is made of mulite or cordierite.

9. The device of claim 1, wherein the size of the surface of the inner container is determined based on a percentage of moisture in the material.

10. The device of claim 1, comprising an extraction unit coupled to the inner container to extract water and/or gases from the container through a screen wherein the screen is made of a material to prevent passage of microwave from the inner container to the extraction unit.

11. The system of claim 10, comprising a vacuum source connected to the extraction unit to serve as a driving force for extracting.

12. The system of claim 1, comprising a unit to introduce high-pressure inert gas into the inner container wherein the high-pressure gas serves as a driving force for extracting.

13. The system of claim 12, wherein the gas comprises carbon dioxide, carbon monoxide or any combination thereof.

14. A system for treating materials by microwave radiation, the system comprising:
two or more treating units arranged in a vertical stack, a first one of the treating units is a top unit and a second one of the treating units is a bottom unit wherein each treating unit has a respective casing and a respective inner container transparent to microwave radiation, the inner containers are stacked such that material to be treated received at an inlet of the inner container of the top unit passes through the inner containers and treated material is discharged through an outlet of the inner container of the bottom unit;
two or more waveguides, each connected to the respective casing of one of the treating units to conduct microwave radiation from a radiation source into the respective casing;
one or more substance extraction units positioned between two subsequent treating units, wherein the substance extraction unit is to extract substance from the material; and
a transport unit coupled to the bottom unit to carry the treated material.

15. The system of claim 14, wherein each respective casing is made of magnetic material.

16. The system of claim 14, wherein the material to be treated is fuel.

17. The system of claim 14, comprising a controller to control a rate of progress of the material through the treating units.

18. The system of claim 11, comprising two or more extraction units to extract water and/or gases from the material through a screen.

19. The system of claim 18, comprising a vacuum source connected to the extraction unit to serve as a driving force for extracting.

20. The system of claim 11, comprising a unit to introduce high-pressure inert gas into the inner container wherein the high-pressure gas serves as a driving force for extracting.

21. The system of claim 20, wherein the gas comprises carbon dioxide, carbon monoxide or any combination thereof.
